(19) United States
(12) Patent Application Publication
(10) Pub. No.: US 2008/0135411 A1
(43) Pub. Date: Jun. 12, 2008

(54) Microfluidic Transport By Electrostatic Deformation of Fluidic Interfaces

(76) Inventors: Lorne A. Whitehead, Vancouver (CA); Januk S. Aggarwal, Albany, OH (US)

Correspondence Address: PAULY, DEVRIES SMITH & DEFFNER, L.L.C., Plaza VII-Suite 3000, 45 South Seventh Street, MINNEAPOLIS, MN, 55402-1630, US

(21) Appl. No.: 11/570,718

(22) PCT Filed: Jun. 15, 2005
(86) PCT No.: PCT/CA05/00938

§ 371 Date: Dec. 12, 2007

Related U.S. Application Data
(60) Provisional application No. 60/579,653, filed on Jun. 16, 2004.

(51) Int. Cl. G01N 27/447; B01D 57/02; B03C 5/00

(52) U.S. Cl. 204/547; 204/450; 204/622; 204/643

(57) ABSTRACT

Surface 12's hydrophobic region 26 is surrounded by hydrophilic region 28. Hydrophobic region 26 is coated with first electrical insulator fluid 10 (e.g. oil). Surface 12 and first fluid 10 are submerged in second fluid 14 (e.g. water) having a high dielectric constant value relative to the first fluid's dielectric constant value and/or having non-zero electrical conductivity. An electric field is selectably applied between second fluid 14 and spaced-apart sections of hydrophobic region 26 to form compact volume portions 10A, 10B of first fluid 10 between the spaced-apart sections. Elongated volume portions of first fluid 10 remain on the spaced-apart sections of hydrophobic region 26, fluidicly interconnecting compact volume portions 10A, 10B. If the electric field is sequentially applied to different sections of hydrophobic region 26 during successive time intervals the compact and elongated volume portions of first fluid 10 are redistributed moved to different sections of hydrophobic region 26.

### REFERENCE TO RELATED APPLICATION

This application claims the benefit of U.S. provisional patent application Ser. No. 60/579,653 filed 16 Jun. 2004.

### TECHNICAL FIELD

This application pertains to controllable, electrostatic force movement of fluids over a surface.

### BACKGROUND

Conventional techniques for moving fluid interfaces do not normally permit one to move macroscopic volumes of fluids, or to control the rate at which a fluid moves over a surface. Such control is desirable for small fluid volumes (e.g. droplets, where surface tension forces dominate) since it facilitates formation of lenses or displays having controllably variable optical properties, and facilitates physical movement (“pumping”) of fluid from one location to another.

“Electrowetting” is a common technique in which an electric field is used to modify the wetting behavior of a fluid droplet in order to deform the droplet's fluid interfaces. For example, application of an electric field to one side of a fluid droplet lowers the surface tension on that side, causing the droplet to flow in that direction. Electrowetting techniques are commonly used to move the intersection, or “contact line,” between a droplet and a solid surface, thereby moving the droplet itself. However, the object of such techniques is typically to change the droplet's shape, not to cause net motion of the droplet. In any case, friction and hysteresis forces tend to limit efficient, controllable movement of the contact line thus impeding accurately reversible movement of the droplet between two positions.

More particularly, FIGS. 1A and 1B depict a first fluid (e.g. oil) droplet 10 on a uniform, homogeneous, solid surface 12. Droplet 10 and surface 12 are submerged in a second fluid (e.g. dry air) background medium 14. In the absence of external forces, such as friction, droplet 10 (shown in solid outline in FIGS. 1A and 1B) assumes a smooth, semi-spherical shape on surface 12.

Droplet 10, surface 12 and medium 14 intersect at three interfaces: (1) the interface between droplet 10 and surface 12; (2) the interface between droplet 10 and background medium 14; and (3) the interface between surface 12 and background medium 14. Each interface is characterized by a well-defined surface tension or surface energy, as described by Young's equation:

γ_{SD}+γ_{DB} cos θ₁−γ_{SB}=0

where, γ_{SD} is the surface tension or surface energy at the interface between droplet 10 and surface 12; γ_{DB} is the surface tension or surface energy at the interface between droplet 10 and background medium 14; γ_{SB} is the surface tension or surface energy at the interface between surface 12 and background medium 14; and θ₁ is the contact angle between droplet 10 and surface 12 as shown in FIG. 1A. Young's equation yields a single, unique solution at which the sum of these three surface energies is minimized. This minimum energy state defines the shape of droplet 10. For example, a water droplet submerged in an air background medium will “bead up” when placed on a surface formed of Teflon® or Gortex® material, as the droplet adapts to minimize the total surface energy of the droplet-background medium-surface system. The “contact line” is the line at which the three aforementioned interfaces intersect, shown at 18 in FIGS. 1A and 1B. Since droplet 10 is a semi-sphere, contact line 18 is a circle at the base of droplet 10 where it contacts surface 12.

It is well known that the surface energy relationships at contact line 18 can be changed via the aforementioned electrowetting technique by applying an electric field between droplet 10 and an electrically insulated electrode 20 located beneath surface 12. Specifically, consider the case of a conductive (e.g. water) droplet 10 on surface 12. An electrical potential source 22 can be electrically connected to apply an electrical potential between electrode 20 and droplet 10. This subjects droplet 10 to an electric field, increasing the surface area of droplet 10 as it adapts to minimize the total surface energy of the droplet-background medium-surface system by assuming a somewhat flattened shape 10A (shown in dashed outline in FIGS. 1A and 1B). The surface area increase causes a corresponding contact angle reduction (indicated at θ₂ in FIG. 1A) and a corresponding expansion of the circular contact line (indicated at 18A in FIGS. 1A and 1B) as the droplet spreads out on surface 12.

In theory, electrowetting can be used to efficiently and reproducibly change the shape of droplet 10 on surface 12. However, in practice, surface 12 is insufficiently smooth, or insufficiently chemically homogeneous, or both. Porosity of surface 12, or the presence of chemical impurities or dust particles on surface 12 unpredictably affects the contact angle θ, causing friction as the contact line moves across surface 12. Such friction results in “contact angle hysteresis,” disrupting accurately reversible movement of droplet 10 from an initial position to an intermediate position and back to the same initial position. Efficient, accurately reversible movement of droplet 10 between different positions is a desirable attribute in a number of applications, but attainment of that attribute is often limited by contact angle hysteresis. This disclosure addresses that limitation.

The foregoing examples of the related art and limitations related thereto are intended to be illustrative and not exclusive. Other limitations of the related art will become apparent to those of skill in the art upon a reading of the specification and a study of the drawings.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIGS. 1A and 1B are schematic, cross-sectional side elevation and top plan views respectively, on a greatly enlarged scale, depicting a fluid droplet on a solid surface submerged in a fluid background medium.

FIG. 2 is a top plan view of a closed loop hydrophobic track surrounded by a hydrophilic region.

FIGS. 3A and 3C are cross-sectional end views, on a greatly enlarged scale, taken with respect to line 3A/3C shown in FIG. 2, respectively depicting extended and compacted droplets atop the FIG. 2 track's hydrophobic region. FIGS. 3B and 3D are cross-sectional side views, on a greatly enlarged scale, taken with respect to line 3B/3D shown in FIG. 2, respectively depicting the FIG. 3A and 3C droplets.

FIG. 4 is a top plan view of the FIG. 2 track, showing a plurality of electrodes extending transversely beneath and projecting to either side of the track.

FIG. 5A is an enlarged, cross-sectional end view taken with respect to line 5A-5A shown in FIG. 4, depicting a compacted droplet atop the track's hydrophobic region.

FIG. 5B is an enlarged cross-sectional side view taken with respect to line 5B-5B shown in FIG. 4, depicting extension of the FIG. 5A droplet along the track in response to an applied electric field.

FIGS. 6A and 6B are enlarged side elevation views of a portion of the FIG. 4 track, showing the effect of electrically grounding the depicted electrodes (FIG. 6A) and the effect of applying an electrical potential to every third electrode (FIG. 6B).

FIGS. 7A, 7B, 7C and 7D are enlarged schematic side elevation views of a portion of the FIG. 4 track, showing sub-droplets being moved along the track by sequential application of an electrical potential to every third electrode.

FIG. 8 is a top plan view of a portion of the FIG. 4 track, schematically depicting one possible arrangement for electrically connecting the electrodes.

FIG. 9 is a top plan view of a hydrophobic track surrounded by a hydrophilic region and fluidicly coupled to a reservoir.

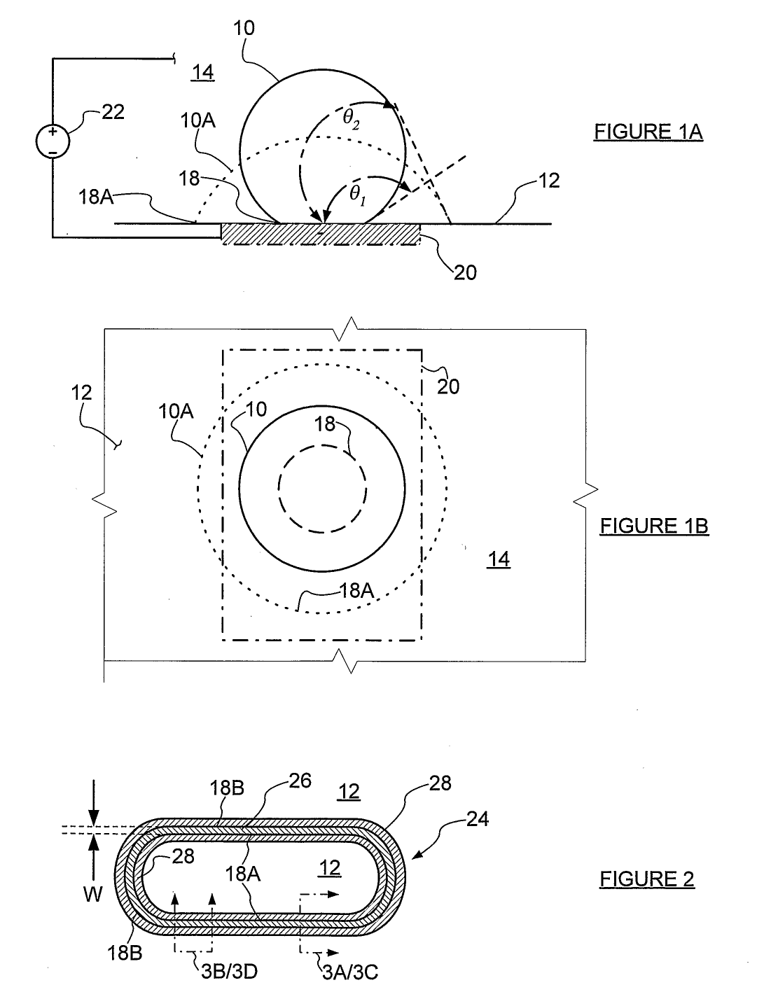

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

As previously explained, friction and hysteresis forces tend to limit efficient, accurately reversible movement of droplet 10 between different positions on surface 12. The effect of this limitation can be reduced by submerging droplet 10 and surface 12 within a different fluid background medium 14. For example, droplet 10 may be formed of a first fluid such as oil and background medium 14 may be a second fluid such as water. As will be explained, the water-submerged oil droplet can be moved efficiently and reversibly between different positions on surface 12.

As shown in FIG. 2, a track 24 is formed on a surface 12 having a first region 26 surrounded by a second region 28. First region 26 meets second region 28 at a inner boundary 18A and at an outer boundary 18B. First region 26 is coated with an electrical insulator first fluid 10 (e.g. oil) having a first dielectric constant value. A droplet of first fluid 10 contacts surface 12 at a variable droplet angle φ. Surface 12 (including track 24, regions 26, 28 and first fluid 10) is submerged in a second fluid or background medium 14 (e.g. water) having a second dielectric constant value greater than the first dielectric constant value and/or having a non-zero electrical conductivity value. First fluid 10 contacts second fluid 14 at an interface which meets surface 12 along a contact line. An electric field is controllably applied between surface 12 and second fluid 14 via suitable electrodes 20, as explained below.

It is only meaningful to refer to a “contact angle” in relation a single surface. FIG. 2 depicts two surface regions, namely first region 26 and second region 28. In the absence of second region 28, contact between first region 26 and the fluid composite consisting of first fluid 10 submerged in second fluid 14 is characterized by a first contact angle. Conversely, in the absence of first region 26, contact between second region 28 and the fluid composite consisting of first fluid 10 submerged in second fluid 14 is characterized by a second contact angle. First region 26 has a first characteristic relative to first and second fluids 10, 14 and second region 28 has a second characteristic relative to first and second fluids 10, 14 such that for a substantial range of volume of first fluid 10 on first region 26, the variable droplet angle φ substantially exceeds the first contact angle and is substantially exceeded by the second contact angle, thereby confining the contact line to the inner and outer boundaries 18A, 18B throughout the substantial range of volume and throughout the range of variable droplet angle φ.

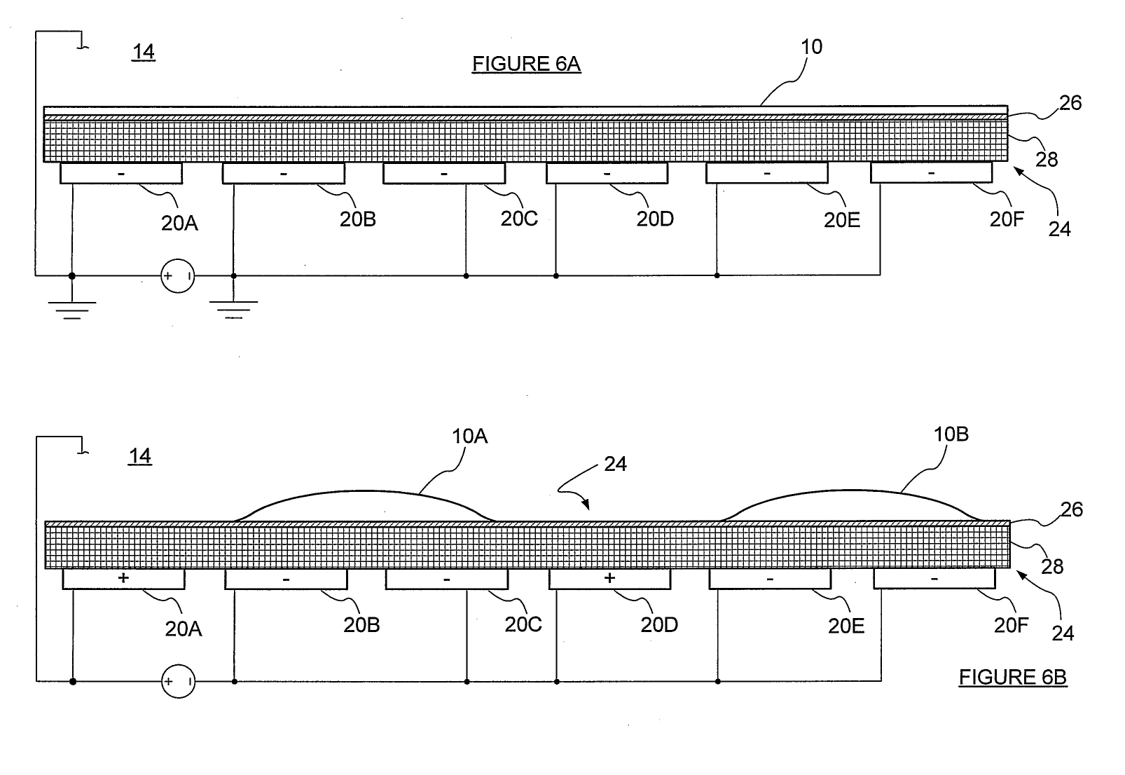

The cumulative volume of a droplet of first fluid 10 on first region 26 does not change. As explained below in relation to FIGS. 5A-6B, the droplet can be redistributed (i.e. moved) along first region 26. During such redistribution, some portions of the droplet may be compacted (i.e. bulge upwardly away from first region 26) at some locations on first region 26, while other portions of the droplet may be extended (i.e. flattened against first region 26) at other locations on first region 26. Although the cumulative volume of such droplet portions does not change, the localized volume of each droplet portion changes throughout a substantial volume range during such redistribution. The preceding paragraph's reference to a “substantial range of volume of first fluid 10 on first region 26” means these localized volume changes.

When an electrical potential is applied between surface 12 and second fluid 14, an electrostatic pressure is produced which alters the shape of the fluidic interface. Specifically, the high dielectric constant and/or non-zero electrical conductivity second fluid 14 (water) tends to preferentially move into the high electric field, displacing the low dielectric constant first fluid 10 (oil) from this vicinity. Water has a dielectric constant value K≈80 at a temperature of about 25° C. and at a frequency of 1,000 Hz, whereas oil has a dielectric constant value between about 2 and 3 at the same temperature and frequency. By contrast, if second fluid 14 has a low dielectric constant value (e.g. dry air, K≈1.0059 at 25° C. and 1,000 Hz) relative to the dielectric constant value of first fluid 10, then when an electrical potential is applied between surface 12 and second fluid 14 it is difficult to attain the aforementioned shape-altering performance.

Track 24 can be a closed loop patterned onto a suitable substrate material. First region 26's first characteristic may constitute a hydrophobic coating on first region 26. Second region 28's second characteristic may constitute a hydrophilic coating on second region 28. The drawings depict hydrophilic-coated second region 28 as a closed loop having a width exceeding the width of central hydrophobic-coated first region 26, but in practice hydrophilic-coated second region 28 may cover the entire surface 12 excepting the portion covered by hydrophobic-coated first region 26.

“Hydrophobic” substances, such as oils, waxes and fats, repel or tend not to combine with water. “Hydrophilic” substances, such as the hydroxyl, carbonyl, carboxyl, amino, sulfhydryl and phosphate functional groups have an affinity for water or are readily absorbed or dissolved in water. First fluid 10 may be a droplet of a fluid such as Dow Corning® OS-30 fluid (a volatile methylsiloxane, referred to herein as “oil,” available from Dow Corning Corporation, Midland, Mich. 48686). Track 24 may be formed by printing a wax-based (i.e. hydrophobic) ink (e.g. ColorStix® 8200 Ink-Black, Xerox Part Number 016-2044-00, available from Xerox Corporation-Office Group, Wilsonville, Oreg. 97070-1000) directly onto a hydrophilic-coated film (e.g. 132 Medium Blue Colour Effects Lighting Filters, available from Lee Filters, Andover, Hampshire, SP10 5AN, England) using a consumer grade ink printer (e.g. a Phaser® 8200DP Solid Ink Printer, Xerox Part Number 8200DP, available from Xerox Corporation, Wilsonville, Oreg. 97070-1000). In this example, the wax-based ink coating constitutes first region 26 and the hydrophilic-coated film constitutes second region 28. Track 24 and regions 26, 28 can be provided in different patterns besides that depicted in FIG. 2.

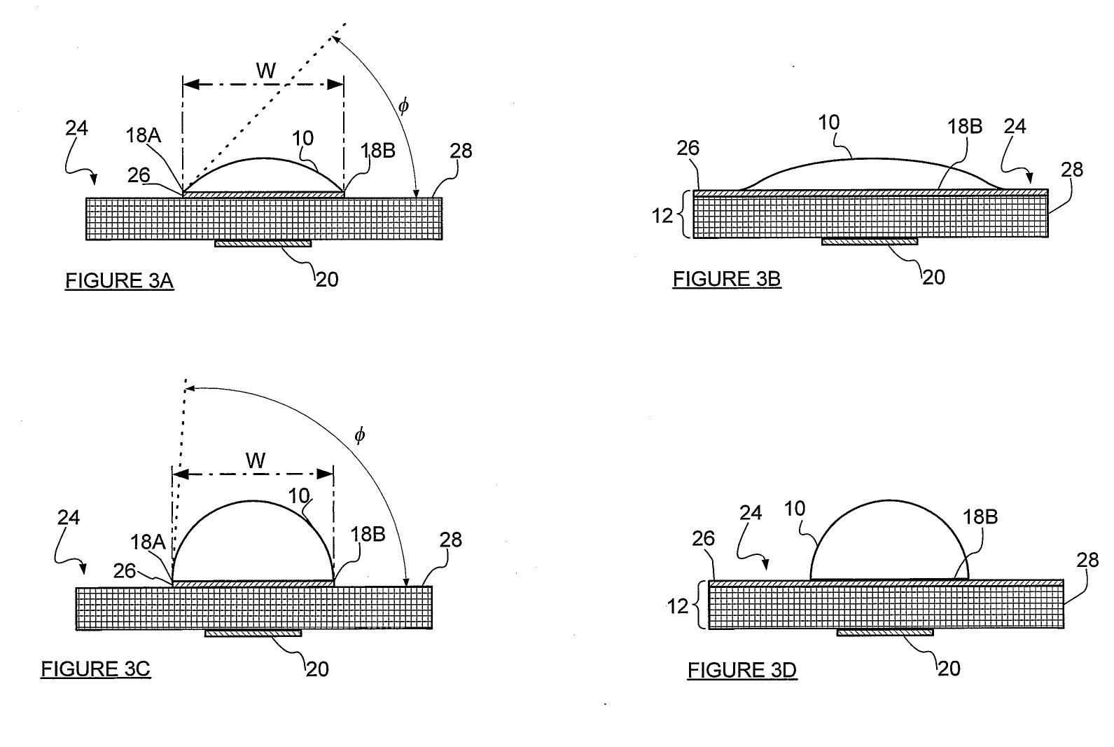

A droplet of first fluid 10 (e.g. oil) “wets” hydrophobic-coated region 26 by leaving a microscopically thin film of oil thereon. More particularly, first fluid 10 wets the entire closed loop central hydrophobic-coated first region 26 of track 24, although an observer will primarily perceive the droplet of first fluid 10 as having an extended form as depicted in FIGS. 3A and 3B, or a compacted form as depicted in FIGS. 3C and 3D, or some intermediate form (not shown), depending upon the manner in which electrodes 20 are actuated as explained below. There are two closed loop contact lines in this situation; a first contact line coinciding with the inner closed loop boundary 18A between track regions 26, 28 and a second contact line coinciding with the outer closed loop boundary 18B between track regions 26, 28. Neither of these contact lines moves, thereby avoiding the aforementioned problems associated with contact line hysteresis, notwithstanding localized changes in the shape of a droplet of first fluid 10 which occur as portions of the droplet bulge, flatten, etc. to minimize the total surface energy of the droplet-background medium-surface system in response to different electric fields applied between electrode 20 and second fluid 14.

Persons skilled in the art will understand that although it is convenient to describe some aspects of the invention in electrowetting terms, the invention also involves electrostatic deformation of the fluid interfaces. More specifically, second fluid 14 (e.g. water) is attracted toward surface 12 by the electric field around electrode 20. Second fluid 14 does not wet hydrophobic-coated first region 26, so it is energetically favorable for a thin layer of first fluid 10 (oil) to remain on hydrophobic-coated first region 26. Since second fluid 14 does not completely displace first fluid 10, the contact lines remain in the same position on surface 12, as desired (i.e. the contact lines coincide respectively with inner and outer boundaries 18A, 18B).

More particularly, as shown in FIGS. 3A and 3C, the contact lines are confined at boundaries 18A, 18B respectively if the width W of track 24's hydrophobic-coated first region 26 exceeds approximately the height of the droplet of first fluid 10 on first region 26. That is, as the droplet's shape changes to minimize the total surface energy of the oil-water system, the contact lines remain in the same positions on hydrophobic-coated first region 26 (i.e. at boundaries 18A, 18B respectively), throughout a wide range of droplet angles φ. Since the droplet is stable for a wide range of droplet angles φ, the contact lines do not move, even if the droplet undergoes substantial deformation. The droplet is thus confined atop hydrophobic-coated first region 26, between the contact lines.

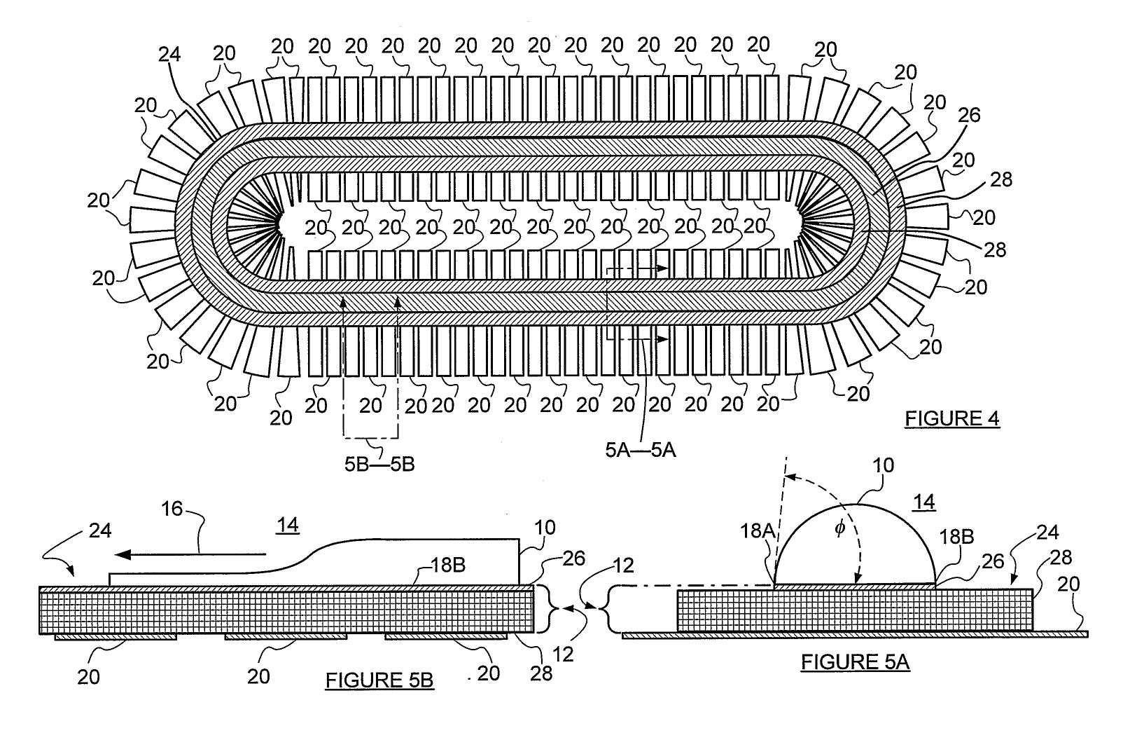

To facilitate localized deformations of the oil-water interface, track 24 can be positioned over a series of electrodes 20 as shown in FIG. 4. Each electrode 20 extends transversely beneath and projects from both sides of track 24. The shape of an oil droplet 10 on hydrophobic-coated first region 26 can be altered by applying an electric field across droplet 10, between one or more of electrodes 20 and second fluid 14 (water) in which oil droplet 10 and track 24 are submerged. When the field is applied, the high dielectric constant water tends to move into the high electric field region(s) as aforesaid, so as to minimize the total surface energy of the system, consequently deforming the low dielectric constant oil droplet 10 by squeezing it away from such region(s). If deformation of droplet 10 is governed by only one of electrodes 20, droplet 10 can be reversibly redistributed (i.e. moved) along a portion of track 24's hydrophobic-coated first region 26 adjacent that electrode, between the compact and extended forms shown in FIGS. 5A and 5B. Specifically, because droplet 10's contact lines are confined at inner and outer boundaries 18A, 18B as aforesaid, droplet 10 is moved along hydrophobic-coated first region 26 between the contact lines without moving crossing either contact lines.

Since deformation of droplet 10 is independent of the direction of the applied electric field, alternating current (AC) fields can be used to control deformation of droplet 10. This is desirable because it prevents charge accumulation on track 24, which would occur if direct current (DC) fields were used to control deformation of droplet 10.

As previously explained, prior art techniques which involve contact line movement during droplet displacement unpredictably affect the contact angle θ, causing friction and contact angle hysteresis, disrupting accurately reversible droplet movement. Since the contact lines which characterize the embodiments of FIGS. 2-6B do not move as droplet 10 is deformed, no frictional or hysteresis effects arise, thus facilitating accurately reversible movement of droplet 10 along track 24's hydrophobic-coated first region 26 by applying an appropriate electrical potential sequence to electrodes 20. Specifically, suitable modulation of the applied field causes net flow of oil droplet 10 as it is squeezed from high electric field regions into low electric field regions. Such flow can be used to transport (i.e. pump) heat along the track, potentially at rates higher than those of conventional solid thermal conductors.

For example, if electrodes 20 are all initially electrically grounded relative to second fluid 14 (i.e. the water in which track 24 electrodes 20 and oil droplet 10 are submerged), and if second fluid 14 is also initially electrically grounded, then no discrete oil droplets will be perceived on track 24. Instead, oil droplet 10 is distributed in a uniformly thin elongated volume film along the entire length of track 24's hydrophobic-coated first region 26, as shown in FIG. 6A. By contrast, if an appropriate electrical potential is applied between second fluid 14 and every third one of electrodes 20 (i.e. the electrodes labelled 20A and 20D in FIG. 6B), then droplet 10 is deformed and redistributed from the FIG. 6A elongated volume film form into a series of compact volume sub-droplets 10A, 10B, etc. with each such sub-droplet being positioned over an adjacent pair of grounded electrodes (i.e. the electrodes labelled 20B, 20C and 20E, 20F in FIG. 6B). Sub-droplets 10A, 10B, etc. are not discontinuous droplets separated by distinct contact lines, since a thin elongated volume oil film remains on track 24's hydrophobic-coated first region 26 and fluidicly interconnects sub-droplets 10A, 10B, etc. But, most of the oil is contained in sub-droplets 10A, 10B, etc. As previously explained, there are two closed loop contact lines in this situation, neither of which moves, thus avoiding contact line hysteresis. In general, it is convenient to refer to these two contact lines as constituting a single contact line.

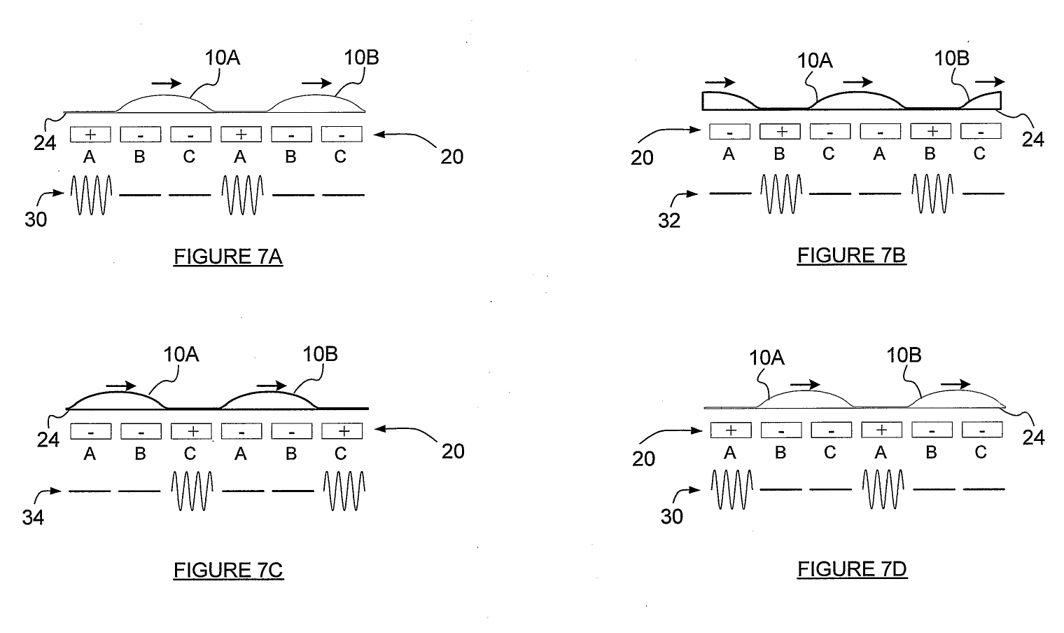

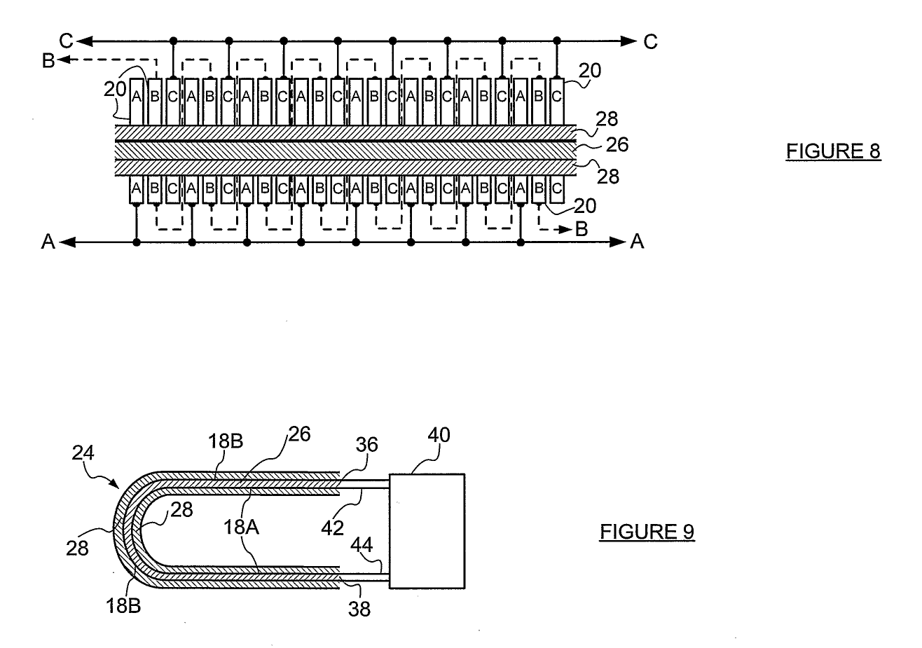

FIGS. 7A, 7B, 7C and 7D schematically show how net flow (i.e. “pumping”) of oil along track 24 can be achieved by sequentially applying an appropriate electrical potential to every third successive one of electrodes 20 along track 24. More particularly, as shown in FIG. 7A, an appropriate electrical potential signal 30 is applied to the electrodes labelled “A” for a first brief time interval, during which the electrodes labelled “B” and “C” remain at ground potential. As previously explained, this forms compact volume sub-droplets 10A, 10B, etc. over the “B” and “C” electrodes, with only a thin extended volume oil film remaining over the “A” electrodes and fluidicly interconnecting sub-droplets 10A, 10B, etc. Electrical potential signal 32 is subsequently applied to the “B” electrodes for a second brief time interval, as shown in FIG. 7B, during which the “A” and “C” electrodes remain at ground potential. As indicated by the arrows in FIG. 7B, this moves sub-droplets 10A, 10B, etc. over the “C” and “A” electrodes, with only a thin oil film remaining over the “B” electrodes and fluidicly interconnecting sub-droplets 10A, 10B, etc. Electrical potential signal 34 is subsequently applied to the “C” electrodes for a third brief time interval, as shown in FIG. 7C, during which the “A” and “B” electrodes remain at ground potential. As indicated by the arrows in FIG. 7C, this moves sub-droplets 10A, 10B, etc. over the “A” and “B” electrodes, with only a thin oil film remaining over the “C” electrodes and fluidicly interconnecting sub-droplets 10A, 10B, etc. The sequence then repeats, with electrical potential signal 30 being applied to the “C” electrodes for another brief time interval, as shown in FIG. 7D, during which the “B” and “C” electrodes remain at ground potential. As indicated by the arrows in FIG. 7D, this moves sub-droplets 10A, 10B, etc. over the “B” and “C” electrodes, with only a thin oil film remaining over the “A” electrodes and fluidicly interconnecting sub-droplets 10A, 10B, etc.

The 3-electrode sequence (i.e. A-B-C-A-B-C shown in FIGS. 7A, 7B, 7C and 7D) is the minimum required to achieve net flow of first fluid 10 along track 24's first region 26. The 3-electrode sequence also achieves maximum volume redistribution of first fluid 10, but, if desired, a longer sequence (i.e. one in which an appropriate electrical potential is sequentially applied to every fourth, or every fifth, etc. electrode) can be used to redistribute first fluid 10 at a lower volume flow rate.

When track 24 was submerged in distilled water, the aforementioned Dow Corning® OS-30 fluid (“oil”) was found to wet the track's wax-coated (i.e. hydrophobic) first region 26 with a droplet angle φ between 0-10°, whereas the oil beaded up on the track's hydrophilic-coated second region 28 with a contact angle between 110-120°. A thin (25 mm) layer of adhesive can be used to bond the underside of the track's hydrophilic region 28 to the electrode layer underneath. Electrodes 20 can be fabricated using standard printed circuit board techniques. If electrodes 20 are grouped in the aforementioned 3-electrode sequence one may utilize the repeating, non-overlapping, interleaved electrode connection pattern shown schematically in FIG. 8 to electrically connect electrodes 20 to electrical potential source 22. The FIG. 8 connection pattern facilitates the aforementioned repeating A-B-C electrode pattern without disruption, since the “B” electrodes are series-connected by conductors which are sufficiently narrow that they do not induce significant deformation of the oil-water interface by perturbing the electric fields produced by electrodes 20. This makes it possible to arbitrarily extend the length of track 24 by repeating the FIG. 8 connection pattern along the desired track length, and requires only three electrical connections at the “A,” “B” and “C” terminals shown in FIG. 8.

Besides facilitating formation of lenses or displays having controllably variable optical properties as aforesaid, the invention has other applications, including, but not limited to, movement of fluid coolants; accurate, droplet-by-droplet movement of fluids (e.g. chemicals or biological materials); and, selection, sorting, and selectable diversion of individual moving fluid droplets.

While a number of exemplary aspects and embodiments have been discussed above, persons skilled in the art will recognize certain modifications, permutations, additions and sub-combinations thereof. For example, track 24 need not form a closed loop. Instead, as shown in FIG. 9, track 24's first region 26 may have an input end 36 and an output end 38. Either or both of ends 36, 38 may be fluidicly coupled to a fluid (e.g. oil) reservoir 40 by fluid conduits 42, 44 respectively. By suitably actuating electrodes 20, one may move (pump) fluid droplets from reservoir 40, along track 24's first region 26 and back to reservoir 40. Alternatively, input end 36 may be coupled to a fluid input reservoir and output end 38 may be coupled to a separate fluid output reservoir, such that suitable actuation of electrodes 20 pumps fluid droplets from the input reservoir, along track 24's first region 26, into the output reservoir. It is therefore intended that the following appended claims and claims hereafter introduced are interpreted to include all such modifications, permutations, additions and sub-combinations as are within their true spirit and scope.

What is claimed is:

1. A method of moving a fluid, comprising:
forming a track (24) on a surface (12) having a first region (26) surrounded by a second region (28), the first region (26) meeting the second region (28) at a boundary (18A, 18B);
coating the first region (26) with an electrical insulator first fluid (10) having a first dielectric constant value, the first fluid (10) contacting the surface at a variable droplet angle (φ);
submerging the surface (12) and the first fluid (10) in a second fluid (14) having at least one of:
(i) a second dielectric constant value greater than the first dielectric constant value; and
(ii) a non-zero electrical conductivity value;
the first fluid (10) contacting the second fluid (14) at an interface, the interface meeting the surface (12) along a contact line;
contact between the first region (26) and the first fluid (10) submerged in the second fluid (14) being characterized by a first contact angle in the absence of the second region (28);
contact between the second region (28) and the first fluid (10) submerged in the second fluid (14) being characterized by a second contact angle in the absence of the first region (26);
controllably applying an electric field between the surface (12) and the second fluid (14); and
the first region (26) having a first characteristic relative to the first and second fluids (10, 14) and the second region (28) having a second characteristic relative to the first and second fluids (10, 14), such that for a substantial range of volume of the first fluid (10) on the first region (26), the variable droplet angle (φ) substantially exceeds the first contact angle and is substantially exceeded by the second contact angle, thereby confining the contact line to the boundary (18A, 18B) throughout the substantial range of volume and throughout the range of the variable droplet angle (φ).

2. A method as defined in claim 1, wherein controllably applying the electric field between the surface (12) and the second fluid (14) further comprises selectably applying the electric field between the second fluid (14) and spaced-apart sections of the first region (26) to form a compact volume portion (10A, 10B) of the first fluid (10) between each one of the spaced-apart sections of the first region (26), the compact volume portions (10A, 10B) of the first fluid (10) fluidicly interconnected by elongated volume portions of the first fluid (10) remaining on the spaced-apart sections of the first region (26).

3. A method as defined in claim 1, wherein controllably applying the electric field between the surface (12) and the second fluid (14) further comprises:
dividing the first region (26) into a plurality of sequentially repeated first, second and third adjacent sections;
during a first time interval, selectably applying the electric field (30) between the second fluid (14) and each one of the first sections to form a compact volume portion (10A, 10B) of the first fluid (10) between each one of the first sections and form an elongated volume portion of the first fluid (10) on each one of the first sections, the compact volume portions (10A, 10B) fluidicly interconnected by the elongated volume portions;
during a second time interval, selectably applying the electric field (32) between the second fluid (14) and each one of the second sections to redistribute the compact volume portions (10A, 10B) of the first fluid (10) between each one of the second sections and redistribute the elongated volume portions of the first fluid (10) on each one of the second sections; and
during a third time interval, selectably applying the electric field (34) between the second fluid (14) and each one of the third sections to redistribute the compact volume portions (10A, 10B) of the first fluid (10) between each one of the third sections and redistribute the elongated volume portions of the first fluid (10) on each one of the third sections.

4. A method as defined in claim 1, 2 or 3 wherein the first fluid (10) is hydrophobic, the second fluid (14) is hydrophilic, the first characteristic is hydrophobic, and the second characteristic is hydrophilic.

5. A method as defined in claim 1, 2 or 3 wherein the first fluid (10) is oil and the second fluid (14) is water.

6. A method as defined in claim 1, 2 or 3 wherein the first fluid (10) is oil, the second fluid (14) is water, the first region (26) is formed of a wax and the second region (28) is formed of a hydrophilic-coated film.

7. A method as defined in claim 1, 2 or 3 further comprising forming the first region (26) in a closed loop.

8. A method as defined in claim 1, 2 or 3 further comprising:
storing the first fluid (10) in a reservoir (40);
forming the first region (26) with an input end (36) and an output end (38); and
fluidicly coupling the input and output ends (36, 38) to the reservoir (40).

9. A method of controllably moving a fluid, comprising:
forming a track (24) on a surface (12) having a hydrophobic region (26) surrounded by a hydrophilic region (28);
coating the hydrophobic region (26) with an electrical insulator first fluid (10) having a first dielectric constant value;
submerging the surface (12) and the first fluid (10) in a second fluid (14) having at least one of:
(i) a second dielectric constant value greater than the first dielectric constant value; and
(ii) a non-zero electrical conductivity value; and
controllably applying an electric field between the surface (12) and the second fluid (14).

10. A method as defined in claim 9, wherein controllably applying the electric field between the surface (12) and the second fluid (14) further comprises selectably applying the electric field between the second fluid (14) and spaced-apart sections of the hydrophobic region (26) to form a compact volume portion (10A, 10B) of the first fluid (10) between each one of the spaced-apart sections of the hydrophobic region (26), the compact volume portions (10A, 10B) of the first fluid (10) fluidicly interconnected by elongated volume portions of the first fluid (10) remaining on the spaced-apart sections of the hydrophobic region (26).

11. A method as defined in claim 9, wherein controllably applying the electric field between the surface (12) and the second fluid (14) further comprises:
dividing the hydrophobic region (26) into a plurality of sequentially repeated first, second and third adjacent sections;
during a first time interval, selectably applying the electric field (30) between the second fluid (14) and each one of the first sections to form a compact volume portion (10A, 10B) of the first fluid (10) between each one of the first sections and form an elongated volume portion of the first fluid (10) on each one of the first sections, the compact volume portions (10A, 10B) fluidicly interconnected by the elongated volume portions;
during a second time interval, selectably applying the electric field (32) between the second fluid (14) and each one of the second sections to redistribute the compact volume portions (10A, 10B) of the first fluid (10) between each one of the second sections and redistribute the elongated volume portions of the first fluid (10) on each one of the second sections; and
during a third time interval, selectably applying the electric field (34) between the second fluid (14) and each one of the third sections to redistribute the compact volume portions (10A, 10B) of the first fluid (10) between each one of the third sections and redistribute the elongated volume portions of the first fluid (10) on each one of the third sections.

12. A method as defined in claim 9, 10 or 11 wherein the first fluid (10) is hydrophobic and the second fluid (14) is hydrophilic.

13. A method as defined in claim 9, 10 or 11 wherein the first fluid (10) is oil and the second fluid (14) is water.

14. A method as defined in claim 9, 10 or 11 wherein the first fluid (10) is oil, the second fluid (14) is water, the hydrophobic region (26) is formed of a wax and the hydrophilic region (28) is formed of a hydrophilic-coated film.

15. A method as defined in claim 9, 10 or 11 further comprising forming the hydrophobic region (26) in a closed loop.

16. A method as defined in claim 9, 10 or 11 further comprising:
storing the first fluid (10) in a reservoir (40);
forming the hydrophobic region (26) with an input end (36) and an output end (38); and
fluidicly coupling the input and output ends (36, 38) to the reservoir (40).

17. Apparatus for moving a fluid, comprising:
a track (24) on a surface (12) having a first region (26) surrounded by a second region (28), the first region (26) meeting the second region (28) at a boundary (18A, 18B);
an electrical insulator first fluid (10) coating the first region (26), the first fluid (10) having a first dielectric constant value and contacting the surface (12) at a variable droplet angle (φ);
the surface (12) and the first fluid (10) submerged in a second fluid (14) having at least one of:
(i) a second dielectric constant value greater than the first dielectric constant value; and
(ii) a non-zero electrical conductivity value;
the first fluid (10) contacting the second fluid (14) at an interface, the interface meeting the surface (12) along a contact line;
contact between the first region (26) and the first fluid (10) submerged in the second fluid (14) being characterized by a first contact angle in the absence of the second region (28);
contact between the second region (28) and the first fluid (10) submerged in the second fluid (14) being characterized by a second contact angle in the absence of the first region (26);
an electrical potential source (22) electrically connected between the surface (12) and the second fluid (14); and
the first region (26) having a first characteristic relative to the first and second fluids (10, 14) and the second region (28) having a second characteristic relative to the first and second fluids (10, 14), such that for a substantial range of volume of the first fluid (10) on the first region (26), the variable droplet angle (φ)) substantially exceeds the first contact angle and is substantially exceeded by the second contact angle, thereby confining the contact line to the boundary (18A, 18B) throughout the substantial range of volume and throughout the range of the variable droplet angle (φ).

18. Apparatus as defined in claim 17, the first region (26) further comprising a plurality of spaced-apart sections, the apparatus further comprising for each one of the spaced-apart sections an electrode (20) adjacent to that one of the spaced-apart sections, each electrode (20) being electrically connected to the electrical potential source (22).

19. Apparatus as defined in claim 17 or 18 wherein the first fluid (10) is hydrophobic, the second fluid (14) is hydrophilic, the first characteristic is hydrophobic, and the second characteristic is hydrophilic.

20. Apparatus as defined in claim 17 or 18 wherein the first fluid (10) is oil and the second fluid (14) is water.

21. Apparatus as defined in claim 17 or 18 wherein the first fluid (10) is oil, the second fluid (14) is water, the first region (26) is formed of a wax and the second region (28) is formed of a hydrophilic-coated film.

22. Apparatus as defined in claim 17 or 18 wherein the first region (26) forms a closed loop.

23. Apparatus as defined in claim 17 or 18 further comprising:
a reservoir (40) containing the first fluid (10);
the first region (26) having an input end (36) fluidicly coupled to the reservoir (40); and
the first region (26) having an output end (38) fluidicly coupled to the reservoir (40).

24. Apparatus as defined in claim 18, further comprising a plurality of electrical conductors electrically connected between the electrodes (20) and the electrical potential source (22), the conductors forming a repeating, non-overlapping, interleaved connection pattern on the surface (12), the conductors being sufficiently thin to prevent perturbation of electric fields produced by the electrodes (20).

25. Apparatus for moving a fluid, comprising:
a track (24) on a surface (12) having a hydrophobic region (26) surrounded by a hydrophilic region (28);
an electrical insulator first fluid (10) on the hydrophobic region (26), the first fluid (10) having a first dielectric constant value;
the surface (12) and the first fluid (10) submerged in a second fluid (14) having at least one of:
(i) a second dielectric constant value greater than the first dielectric constant value; and
(ii) a non-zero electrical conductivity value; and
an electrical potential source (22) electrically connected between the surface (12) and the second fluid (14).

26. Apparatus as defined in claim 25, the hydrophobic region (26) further comprising a plurality of spaced-apart sections, the apparatus further comprising for each one of the spaced-apart sections an electrode (20) adjacent to that one of the spaced-apart sections, each electrode (20) being electrically connected to the electrical potential source (22).

27. Apparatus as defined in claim 25 or 26 wherein the first fluid (10) is hydrophobic and the second fluid (14) is hydrophilic.

28. Apparatus as defined in claim 25 or 26 wherein the first fluid (10) is oil and the second fluid (14) is water.

29. Apparatus as defined in claim 25 or 26 wherein the first fluid (10) is oil, the second fluid (14) is water, the hydrophobic region (26) is formed of a wax and the hydrophilic region (28) is formed of a hydrophilic-coated film.

30. Apparatus as defined in claim 25 or 26 wherein the hydrophobic region (26) forms a closed loop.

31. Apparatus as defined in claim 25 or 26 further comprising:
a reservoir (40) containing the first fluid (10);
the hydrophobic region (26) having an input end (36) fluidicly coupled to the reservoir (40); and
the hydrophobic region (26) having an output end (38) fluidicly coupled to the reservoir (40).

32. Apparatus as defined in claim 26, further comprising a plurality of electrical conductors electrically connected between the electrodes (20) and the electrical potential source (22), the conductors forming a repeating, non-overlapping, interleaved connection pattern on the surface (12), the conductors being sufficiently thin to prevent perturbation of electric fields produced by the electrodes (20).
